(19) United States
(12) Patent Application Publication
(10) Pub. No.: US 2026/0199178 A1
(43) Pub. Date: Jul. 16, 2026

(54) SYSTEM AND METHOD FOR INTERACTION BETWEEN ARTIFICIAL INTELLIGENCE AND ADULT TOY

(71) Applicant: PURE IMAGINATION AI PTE. LTD., CENTRAL REGION (SG)

(72) Inventor: YING LI, Lianyungang (CN)

(21) Appl. No.: 19/026,366

(22) Filed: Jan. 17, 2025

(30) Foreign Application Priority Data
Dec. 10, 2024 (CN) 202411806771.X

(51) Int. Cl. A61H 19/00

(52) U.S. Cl. CPC A61H 19/00; A61H 2201/5097

(57) ABSTRACT

The present disclosure provides a system and method for interaction between artificial intelligence (AI) and an adult toy, falling within the technical field of adult products. The system includes a terminal control module, a server and a toy module. In the present disclosure, a conversation with a user is accessed through an AI role model, and the AI role model becomes a virtual object in the user's mind and recognizes and converts the user's intention in the process of language interaction into instructions for controlling the execution of the adult toy, breaking the traditionally stereotyped instruction operations, and ensuring that the user can be immersed in the interactive use scene of the toy, with the good use effect of the adult toy.

### CROSS-REFERENCE TO RELATED APPLICATION

This application claims priority of Chinese Patent Application No. 202411806771.X, filed on Dec. 10, 2024, the entire contents of which are incorporated herein by reference.

### TECHNICAL FIELD

The present disclosure belongs to the technical field of adult products, and particularly relates to a system and method for interaction between artificial intelligence (AI) and an adult toy.

### BACKGROUND

Adult toys refer to some auxiliary sexual products that help adults get sexual assistance, which can not only add sexual interest and improve the quality of sexual love, but also bring positive effects to sexual health.

Currently, for the control of adult toys, there are buttons on the adult toys, and the toys are directly controlled by clicking the buttons, or through control terminals (e.g., mobile applications, APPs) where control instructions are issued by operating interfaces on the control terminals. However, these control methods appear dull. A user needs to turn the attention to the harsh control methods, which makes the user unable to be involved in interactive use scenes of the toys, resulting in poor use effect.

### SUMMARY

An object of the present disclosure is to provide a system and method for interaction between AI and an adult toy to solve the above existing problems.

On the one hand, to achieve the above object, the present disclosure provides the following technical solutions. A system for interaction between AI and an adult toy includes a terminal control module, a server and a toy module. The terminal control module is communicatively connected to the server, and the terminal control module is configured to recognize the content of user's instruction dialogues and upload the content to the server; an AI dialogue model within the server is configured to receive and parse the content of the dialogues, and an adult toy instruction module within the server is configured to send an instruction set corresponding to the parsed content to the terminal control module; and the terminal control module is communicatively connected to the toy module, and the terminal control module is configured to forward the instruction set to the toy module to cause the toy module to perform corresponding functional operations.

In a further description of the above technical solution:
the terminal control module is a mobile APP and/or a personal computer (PC).

In a further description of the above technical solution:
the terminal control module communicates with the toy module through Bluetooth.

In a further description of the above technical solution:
an instruction training module is arranged within the AI dialogue model.

In a further description of the above technical solution:
a scene switching module is arranged within the AI dialogue model.

On the other hand, to achieve the above object, the present disclosure provides a method for interaction between AI and an adult toy, including the following steps:
In 1) model training: an AI dialogue model is accessed into a training model related to an adult use scene, and a dialogue is recognized as a control instruction for the adult toy. The AI model used in a dialogue control toy is a neural network model based on a deep learning framework, and its architecture combines the advantages of a convolutional neural network (CNN) and a recurrent neural network (RNN). The CNN part is used for feature extraction of input speech signals or text information, and can effectively capture local feature patterns in data, such as spectral features of speech, and lexical morphological features of text. While the RNN part, especially a long-term and short-term memory network (LSTM) or a gated recurrent unit (GRU), is good at processing sequence data and performing context correlation analysis on the extracted feature sequence, to understand a semantic logic and a temporal relationship of the dialogue and realize accurate dialogue intention recognition and response generation. The model is mainly developed and trained using Python language.

In 2) toy action instruction generation: an action instruction set of a toy module is stored within an adult toy instruction module, and these instructions are accessed into the model training. A corpus intention knowledge base of AI reply content is established, and different intention levels are mapped to corresponding Bluetooth instruction groups through the division of intention levels. Each Bluetooth instruction group is defined based on a Bluetooth protocol and corresponds to a set of specific functional instructions. These functional instructions are embodied in the form of a time series as a series of sampled intensity values. Values of multiple functions can be combined to generate a set of composite motion function curves, and this set of composite motion curves is the core source of Bluetooth instruction data required by the toy to finally execute the action.

In 3) scene interaction: a user's conversation is accessed to a server through a terminal control module, the AI dialogue model engages in the conversation with the user and parses the content of the dialogue, and the adult toy instruction module sends an instruction set corresponding to the parsed content to the terminal control module.

In (4) toy execution: the terminal control module and the toy module are communicatively connected, and the terminal control module forwards the instruction set to the toy module, to cause the toy module to perform the corresponding functional operations.

In summary, due to the adoption of the above technical solution, the present disclosure has the beneficial effects that:

In the present disclosure, a conversation with a user is accessed through an AI role model, and the AI role model becomes a virtual object in the user's mind and recognizes and converts the user's intention in the process of language interaction into instructions for controlling the execution of the adult toy, breaking the traditionally stereotyped instruction operations, and ensuring that the user can be immersed in the interactive use scene of the toy, with the good use effect of the adult toy.

### BRIEF DESCRIPTION OF THE DRAWINGS

FIG. 1 is a block diagram of a system for interaction between AI and an adult toy.

FIG. 2 is a flow chart of a method for interaction between AI and an adult toy.

### DETAILED DESCRIPTION

In order to make the object, technical solutions and advantages of examples of the present disclosure clearer, the technical solutions in the examples of the present disclosure are described clearly and completely below with reference to the attached drawings in the examples of the present disclosure. Obviously, all the described examples are only some, rather than all examples of the present disclosure. Components of the examples of the present disclosure generally described and illustrated in the attached drawings herein can be arranged and designed in various different configurations. Therefore, the following detailed description of examples of the present disclosure provided in the attached drawings is not intended to limit the scope of the claimed disclosure, but merely represents selected examples of the present disclosure. Based on the examples in the present disclosure, all other examples obtained by those of ordinary skill in the art without creative efforts belong to the scope of protection of the present disclosure. It is to be noted that similar numerals and letters indicate similar items in the following drawings, so once an item is defined in one drawing, it does not need to be further defined and explained in subsequent drawings. In the description of the example of the present disclosure, it is to be noted the orientation or positional relationship indicated by the terms “upper” and “inner”, or the orientation or position relationship that a product of the present disclosure is usually placed in use, is based on that shown in the attached drawings and merely for the ease of describing the present disclosure and simplifying the description, rather than indicating or implying that the device or element referred to must be in a specific orientation, and constructed and operated in a specific orientation. Therefore, it is not to be understood as a limitation of the present disclosure. In the description of the present disclosure, it is to be noted that unless otherwise specified and limited, the terms “arranged”, “mounted”, “linked” and “connected” are to be understood in a broad sense, for example, “connected” may be fixedly connected, detachably connected, integrally connected, directly connected or indirectly connected through an intermediate medium, or an internal communication between two elements. For those ordinarily skilled in the art, the specific meanings of the above terms in the present disclosure can be understood according to specific situations.

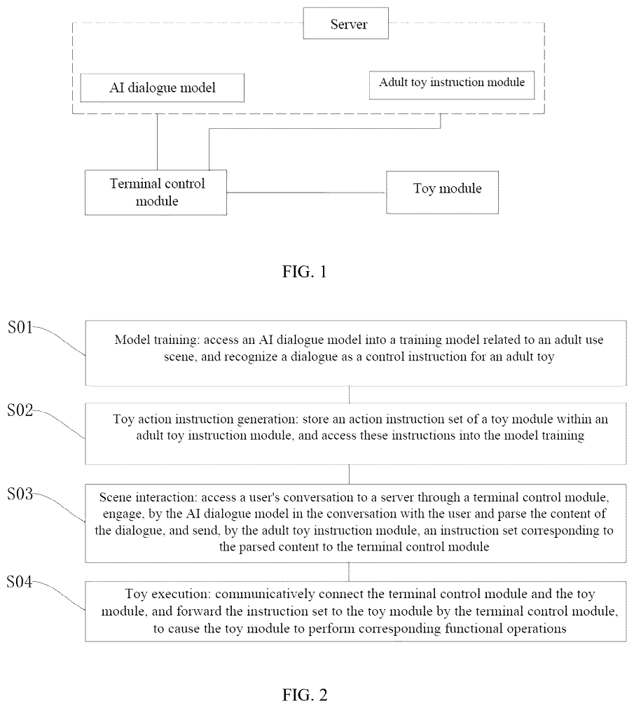

Referring to FIGS. 1-2, the present disclosure provides a technical solution: a system for interaction between AI and an adult toy includes a terminal control module, a server and a toy module. The terminal control module is communicatively connected to the server, and the terminal control module is configured to recognize the content of user's instruction dialogues and upload the content to the server; an AI dialogue model within the server is configured to receive and parse the content of the dialogues, and an adult toy instruction module within the server is configured to send an instruction set corresponding to the parsed content to the terminal control module; and the terminal control module is communicatively connected to the toy module, and the terminal control module is configured to forward the instruction set to the toy module to cause the toy module to perform corresponding functional operations.

The terminal control module is a mobile APP and/or a PC;
the terminal control module communicates with the toy module through Bluetooth; and
an instruction training module is arranged within the AI dialogue model.

### EXAMPLE

In S01, model training: an AI dialogue model is accessed into a training model related to an adult use scene, and a dialogue is recognized as a control instruction for the adult toy. The AI model used in a dialogue control toy is a neural network model based on a deep learning framework, and its architecture combines the advantages of a CNN and an RNN. The CNN part is used for feature extraction of input speech signals or text information, and can effectively capture local feature patterns in data, such as spectral features of speech, and lexical morphological features of text. While the RNN part, especially an LSTM or a GRU, is good at processing sequence data and performing context correlation analysis on the extracted feature sequence, to understand a semantic logic and a temporal relationship of the dialogue and realize accurate dialogue intention recognition and response generation. The model is mainly developed and trained using Python language.

In S02, toy action instruction generation: an action instruction set of a toy module is stored within an adult toy instruction module, and these instructions are accessed into the model training. A corpus intention knowledge base of AI reply content is established, and different intention levels are mapped to corresponding Bluetooth instruction groups through the division of intention levels. Each Bluetooth instruction group is defined based on a Bluetooth protocol and corresponds to a set of specific functional instructions. These functional instructions are embodied in the form of a time series as a series of sampled intensity values. Values of multiple functions can be combined to generate a set of composite motion function curves, and this set of composite motion curves is the core source of Bluetooth instruction data required by the toy to finally execute the action.

In S03, scene interaction: a user's conversation is accessed to a server through a terminal control module, the AI dialogue model engages in the conversation with the user and parses the content of the dialogue, and the adult toy instruction module sends an instruction set corresponding to the parsed content to the terminal control module.

After a specific user's control terminal (mobile APP or PC) is connected to a server, it can enter a voice dialogue page with the AI model, every word that the user says will get interactive feedback from the AI dialogue model, and the interactive feedback is in the form of speech.

In S04, toy execution: the terminal control module and the toy module are communicatively connected, and the terminal control module forwards the instruction set to the toy module, to cause the toy module to perform the corresponding functional operations.

The above is only the preferred example of the present disclosure, rather than limiting the scope of protection of the present disclosure. Within the technical scope disclosed by the present disclosure, any equivalent substitutions or changes made by those skilled in the art according to the technical solution and the inventive concept of the present disclosure are to be covered by the scope of protection of the present disclosure.

1. A system for interaction between artificial intelligence (AI) and an adult toy, comprising a terminal control module, a server and a toy module, wherein the terminal control module is communicatively connected to the server, and the terminal control module is configured to recognize the content of user's instruction dialogues and upload the content to the server; an AI dialogue model within the server is configured to receive and parse the content of the dialogues, and an adult toy instruction module within the server is configured to send an instruction set corresponding to the parsed content to the terminal control module; and the terminal control module is communicatively connected to the toy module, and the terminal control module is configured to forward the instruction set to the toy module to cause the toy module to perform corresponding functional operations.

2. The system for interaction between AI and an adult toy according to claim 1, wherein the terminal control module is a mobile application (APP) and/or a personal computer (PC).

3. The system for interaction between AI and an adult toy according to claim 1, wherein the terminal control module communicates with the toy module through Bluetooth.

4. The system for interaction between AI and an adult toy according to claim 1, wherein an instruction training module is arranged within the AI dialogue model.

5. The system for interaction between AI and an adult toy according to claim 1, wherein a scene switching module is arranged within the AI dialogue model.

6. A method for interaction between AI and an adult toy based on the system for interaction between AI and an adult toy according to claim 1, comprising the following steps:
1) model training: accessing the AI dialogue model into a training model related to an adult use scene, and recognizing the dialogue as a control instruction for the adult toy;
2) toy action instruction generation: storing an action instruction set of the toy module within the adult toy instruction module, and accessing these instructions into the model training;
3) scene interaction: accessing a user's conversation to the server through the terminal control module, engaging, by the AI dialogue model in the conversation with the user and parsing the content of the dialogue, and sending, by the adult toy instruction module, an instruction set corresponding to the parsed content to the terminal control module; and
4) toy execution: communicatively connecting the terminal control module and the toy module, and forwarding the instruction set to the toy module by the terminal control module, to cause the toy module to perform the corresponding functional operations.

7. A method for interaction between AI and an adult toy based on the system for interaction between AI and an adult toy according to claim 2, comprising the following steps:
1) model training: accessing the AI dialogue model into a training model related to an adult use scene, and recognizing the dialogue as a control instruction for the adult toy;
2) toy action instruction generation: storing an action instruction set of the toy module within the adult toy instruction module, and accessing these instructions into the model training;
3) scene interaction: accessing a user's conversation to the server through the terminal control module, engaging, by the AI dialogue model in the conversation with the user and parsing the content of the dialogue, and sending, by the adult toy instruction module, an instruction set corresponding to the parsed content to the terminal control module; and
4) toy execution: communicatively connecting the terminal control module and the toy module, and forwarding the instruction set to the toy module by the terminal control module, to cause the toy module to perform the corresponding functional operations.

8. A method for interaction between AI and an adult toy based on the system for interaction between AI and an adult toy according to claim 3, comprising the following steps:
1) model training: accessing the AI dialogue model into a training model related to an adult use scene, and recognizing the dialogue as a control instruction for the adult toy;
2) toy action instruction generation: storing an action instruction set of the toy module within the adult toy instruction module, and accessing these instructions into the model training;
3) scene interaction: accessing a user's conversation to the server through the terminal control module, engaging, by the AI dialogue model in the conversation with the user and parsing the content of the dialogue, and sending, by the adult toy instruction module, an instruction set corresponding to the parsed content to the terminal control module; and
4) toy execution: communicatively connecting the terminal control module and the toy module, and forwarding the instruction set to the toy module by the terminal control module, to cause the toy module to perform the corresponding functional operations.

9. A method for interaction between AI and an adult toy based on the system for interaction between AI and an adult toy according to claim 4, comprising the following steps:
1) model training: accessing the AI dialogue model into a training model related to an adult use scene, and recognizing the dialogue as a control instruction for the adult toy;
2) toy action instruction generation: storing an action instruction set of the toy module within the adult toy instruction module, and accessing these instructions into the model training;
3) scene interaction: accessing a user's conversation to the server through the terminal control module, engaging, by the AI dialogue model in the conversation with the user and parsing the content of the dialogue, and sending, by the adult toy instruction module, an instruction set corresponding to the parsed content to the terminal control module; and
4) toy execution: communicatively connecting the terminal control module and the toy module, and forwarding the instruction set to the toy module by the terminal control module, to cause the toy module to perform the corresponding functional operations.

10. A method for interaction between AI and an adult toy based on the system for interaction between AI and an adult toy according to claim 5, comprising the following steps:
1) model training: accessing the AI dialogue model into a training model related to an adult use scene, and recognizing the dialogue as a control instruction for the adult toy;
2) toy action instruction generation: storing an action instruction set of the toy module within the adult toy instruction module, and accessing these instructions into the model training;
3) scene interaction: accessing a user's conversation to the server through the terminal control module, engaging, by the AI dialogue model in the conversation with the user and parsing the content of the dialogue, and sending, by the adult toy instruction module, an instruction set corresponding to the parsed content to the terminal control module; and
4) toy execution: communicatively connecting the terminal control module and the toy module, and forwarding the instruction set to the toy module by the terminal control module, to cause the toy module to perform the corresponding functional operations.
